(19) United States
(12) Patent Application Publication
(10) Pub. No.: US 2012/0223976 A1
(43) Pub. Date: Sep. 6, 2012

(54) LIQUID CRYSTAL DISPLAY APPARATUS AND DRIVING METHOD THEREOF

(75) Inventor: Chueh-Pin Ko, New Taipei City (TW)

(73) Assignee: ACER INCORPORATED, New Taipei City (TW)

(21) Appl. No.: 13/237,956

(22) Filed: Sep. 21, 2011

(30) Foreign Application Priority Data
Mar. 2, 2011 (TW) 100106903

(51) Int. Cl. G09G 5/10; G09G 3/36

(52) U.S. Cl. 345/690; 345/102

(57) ABSTRACT

A liquid crystal display (LCD) apparatus and a driving method are provided. The LCD apparatus includes a LCD panel, an over-driving voltage provider and a backlight module. The LCD panel has a plurality of pixel units arranged in an array. The over-driving voltage provider is arranged for providing a plurality of over-driving voltages to drive the pixel units separately, such that times for liquid crystal of the pixel units rotating to a steady state are the same. A turn-on time of the backlight module is determined according to a number of the pixel units with the liquid crystals rotated to the steady state under the received over-driving voltages.

### CROSS-REFERENCE TO RELATED APPLICATION

This application claims the priority benefit of Taiwan application serial no. 100106903, filed on Mar. 2, 2011. The entirety of the above-mentioned patent application is hereby incorporated by reference herein and made a part of this specification.

### BACKGROUND

1. Field of the Invention

The invention relates to a liquid crystal display apparatus and a driving method thereof. Particularly, the invention relates to a liquid crystal display apparatus capable of mitigating a motion blur phenomenon and a driving method thereof.

2. Description of Related Art

Current liquid crystal display (LCD) apparatus are developed towards a trend of large size, high response speed (60→120→240 Hz) and light emitting diode (LED) backlight module. However, regarding a design of the conventional LCD apparatus, turning on/off of the backlight module is generally non-related to a liquid crystal rotation and an image response speed of the LCD apparatus.

According to a conventional technique, two methods can be used to control the backlight module, and one is to maintain a full turn-on state, and another one is to turn on/off the backlight module in a fixed period. The corresponding LCD panel is still driven through a normal method, or a set of driving look-up table is used to improve a response speed of the liquid crystal through an over-driving approach.

In overall, since the backlight module is still fully turned on under a frame period, the LCD apparatus driven through the above methods still has a so-called motion blur phenomenon, which may cause an unclear image state in each frame period. Particularly, the motion blur phenomenon is more severe for a large size LCD apparatus.

### SUMMARY OF THE INVENTION

The invention is directed to a liquid crystal display (LCD) apparatus and a driving method thereof, which can effectively reduce a motion blur phenomenon of the LCD apparatus.

The invention provides a liquid crystal display (LCD) apparatus including a LCD panel, an over-driving voltage provider and a backlight module. The LCD panel has a plurality of pixel units arranged in an array. The over-driving voltage provider is coupled to the LCD panel for providing a plurality of over-driving voltages to respectively drive the pixel units, such that rotating speed for liquid crystals of the pixel units rotating to a steady state are the same. The backlight module is arranged for determining a turn-on time according to a number of the pixel units with the liquid crystals rotated to the steady state under the corresponding received over-driving voltages.

The invention provides a driving method of a LCD apparatus, where the LCD apparatus has a plurality of pixel units arranged in an array. A plurality of over-driving voltages is provided to respectively drive the pixel units, such that rotating speeds for liquid crystals of the pixel units rotating to a steady state are the same. Moreover, a turn-on time of a backlight module of the LCD apparatus is determined according to a number of the pixel units with the liquid crystals rotated to the steady state under the corresponding received over-driving voltages.

According to the above descriptions, in the invention, the corresponding over-driving voltages are provided to the pixel units in the LCD panel, and a rotation speed of the liquid crystal of the pixel unit driven later is accelerated. In this way, the liquid crystal of all of the pixel units may consistently trend to the steady state. Moreover, the turn-on time of the backlight module of the LCD apparatus is determined according to the number of the pixel units with the liquid crystals rotated to the steady state. In this way, stableness of the image displayed on the LCD apparatus can be improved, and the motion blur phenomenon can be mitigated.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic diagram of a liquid crystal display (LCD) apparatus according to an embodiment of the invention.

FIG. 1B is a schematic diagram of display regions of a LCD panel of FIG. 1A.

FIGS. 2A-2C are schematic diagrams respectively illustrating a backlight module turned on at different time points according to an embodiment of the invention.

FIG. 3 is a flowchart illustrating a driving method of a display apparatus according to an embodiment of the invention.

### DETAILED DESCRIPTION OF DISCLOSED EMBODIMENTS

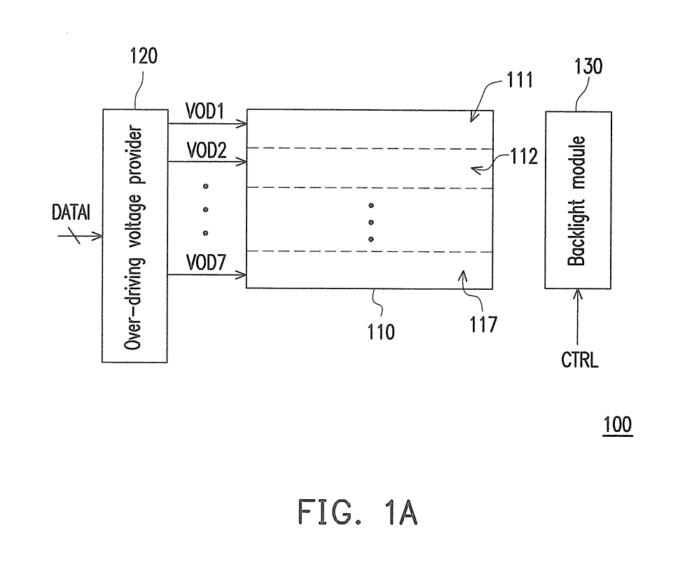

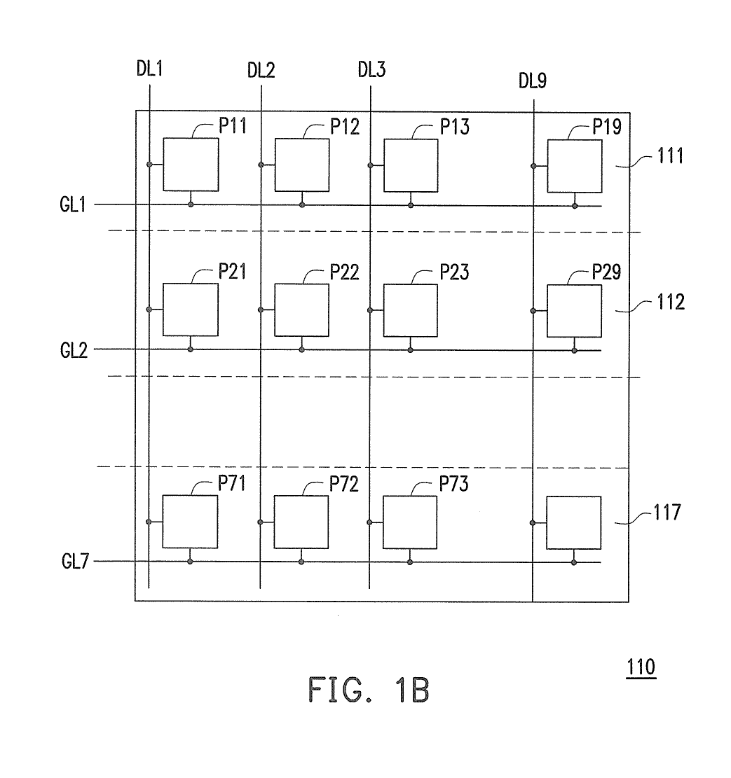

Referring to FIG. 1A, FIG. 1A is a schematic diagram of a liquid crystal display (LCD) apparatus 100 according to an embodiment of the invention. The LCD apparatus 100 includes a LCD panel 110, an over-driving voltage provider 120 and a backlight module 130. The LCD panel 110 has a plurality of pixel units arranged in an array. The LCD panel 110 is divided into a plurality of display regions 111-117 according to a driving sequence of the pixel units. A schematic diagram of display regions of the LCD panel 110 of FIG. 1A of FIG. 1B is referred in order to clearly describe a dividing method of the display regions 111-117 of the present embodiment.

As shown in FIG. 1B, the LCD panel 110 has a plurality of pixel units P11-P73 arranged in an array. The pixel units P11-P73 respectively receive signals transmitted by scan lines GL1-GL7 and data lines DL1-DL9, and are driven by the received signals. The Pixel units P11-P19, P21-P29 and P71-P79 respectively arranged in the same row respectively receive the signals of the scan lines GL1, GL2 and GL7. If the LCD panel 110 is set to be sequentially driven from an upper row to a lower row shown in FIG. 1B, the pixel units P11-P19 connected to the scan line GL1 are first driven, and the pixel units P21-P29 connected to the scan line GL2 are driven in a sequence later than that of the P11-P19. Moreover, the pixel units P71-P79 connected to the scan line GL7 are driven last.

The LCD panel 110 can be divided into the display regions 111-117 according to a time sequence that the pixel units P11-P79 are driven in a same frame period. In detail, as shown in FIG. 1B, the pixel units P11-P19 connected to the scan line GL1 are divided into the display region 111, the pixel units P21-P29 connected to the scan line GL2 are divided into the display region 112, and the pixel units P71-P79 connected to the scan line GL7 are divided into the display region 117.

Certainly, the above method of dividing the display regions according to the scan lines GL1-GL7 is only an example, and during an actual application, the pixel units P11-P29 connected to two scan lines GL1 and GL2 can be divided into a same display region, or the pixel units connected to more adjacent scan lines can be divided into a same display region.

Referring to FIG. 1A again, the over-driving voltage provider 120 is coupled to the LCD panel 120 for providing a plurality of different over-driving voltages VOD1-VOD7 to the display regions 111-117, so as to respectively drive the pixel units in the display regions 111-117, where the over-driving voltages VOD1-VOD7 are respectively provided to the pixel units in the display regions 111-117 driven at different time points in a same frame period. In the same frame period, if the display region 111 is driven first and the display region 117 is driven last, a rotation speed of the liquid crystal of the pixel unit in the display region 111 that is driven by the over-driving voltage VOD1 is slower than a rotation speed of the liquid crystal of the pixel unit in the display region 117 that is driven by the over-driving voltage VOD7 (for example, the over-driving voltage VOD1 is smaller than the over-driving voltage VOD7). Comparatively, in the same frame period, if the display region 111 is driven later and the display region 117 is driven earlier, the rotation speed of the liquid crystal of the pixel unit in the display region 111 that is driven by the over-driving voltage VOD1 is faster than the rotation speed of the liquid crystal of the pixel unit in the display region 117 that is driven by the over-driving voltage VOD7 (for example, the over-driving voltage VOD1 is greater than the over-driving voltage VOD7).

Since the rotation speed of the liquid crystal of the pixel unit driven later is faster than the rotation speed of the liquid crystal of the pixel unit driven earlier, the liquid crystal of the pixel units in the LCD panel 110 can quickly and consistently reach a steady state.

It should be noticed that the over-driving voltages VOD1-VOD7 provided by the over-driving voltage provider 120 can be generated according to pixel data DATAI to be displayed by the corresponding driven pixels. Moreover, the over-driving voltage provider 120 can be configured in a source driver of the LCD apparatus 100, and the over-driving voltages can be transmitted the pixel units through the data lines shown in FIG. 1B. Related technique of driving the LCD apparatus 100 through the source driver and a gate driver is known by those skilled in the art, which is not repeated herein.

The over-driving voltage provider 120 can be constructed by a plurality of over-driving look-up tables. Namely, a plurality of different over-driving look-up tables is established according to the over-driving voltages required for driving the different display regions. When the pixel data DATAI of the corresponding pixel units to be driven is received, the required over-driving voltages can be looked up from the over-driving look-up tables, where these over-driving look-up tables are, for example, stored in a memory. Alternatively, the over-driving voltage provider 120 can also be constructed by a controller having a computation capability. The controller having the computation capability can calculate the required over-driving voltages through software programs.

Certainly, the over-driving voltage provider 120 can also determine a voltage value of the over-driving voltage according to a difference of the pixel data DATAI of the pixel unit of the same position during two adjacent or a plurality of frame periods.

Alternatively, the over-driving voltages can also be generated according to different gray-level designs. Namely, by changing the pixel data DATAI to be displayed by each of the pixels, a time for the pixel reaching the steady state is changed. For example, the gray-level of the pixel data DATAI is increased to shorten the time for reaching the steady state.

On the other hand, the backlight module 130 receives a control signal CTRL, and is turned on/off according to the control signal CRTL. The control signal CTRL is determined according to a number of the pixel units in the LCD panel 110 with the liquid crystals rotated to the steady state under the corresponding received over-driving voltages VOD1-VOD7. Moreover, a turn-on time of the backlight module 130 is controlled by enabling and disabling the control signal CTRL.

In detail, the display regions 111-117 of the LCD panel 110 respectively receive different over-driving voltages VOD1-VOD7 during a same frame period, so that the liquid crystals of the pixel units therein are correspondingly rotated. When a ratio between a number of the pixel units with the liquid crystals rotated to the steady state and a total number of the pixel units is greater than a predetermined ratio, the backlight module 130 is correspondingly turned on by the enabled control signal CTRL.

Here, the aforementioned predetermined ratio can be set or adjusted by a designer. Generally, the predetermined ratio is unnecessary to be set to 100%. For example, when the ratio between the number of the pixel units with the liquid crystals rotated to the steady state and the total number of the pixel units is greater than 30% or 60%, the backlight module 130 is turned on by the enabled control signal CTRL.

It should be noticed that a turn-off time point of the backlight module 130 has to be after a time when all of the pixel units are in the steady state. Namely, when all of the pixel units are in the steady state, the backlight module 130 has to be turned on. Moreover, a length of the turn-on time of the backlight module 130 cannot be greater than one frame period.

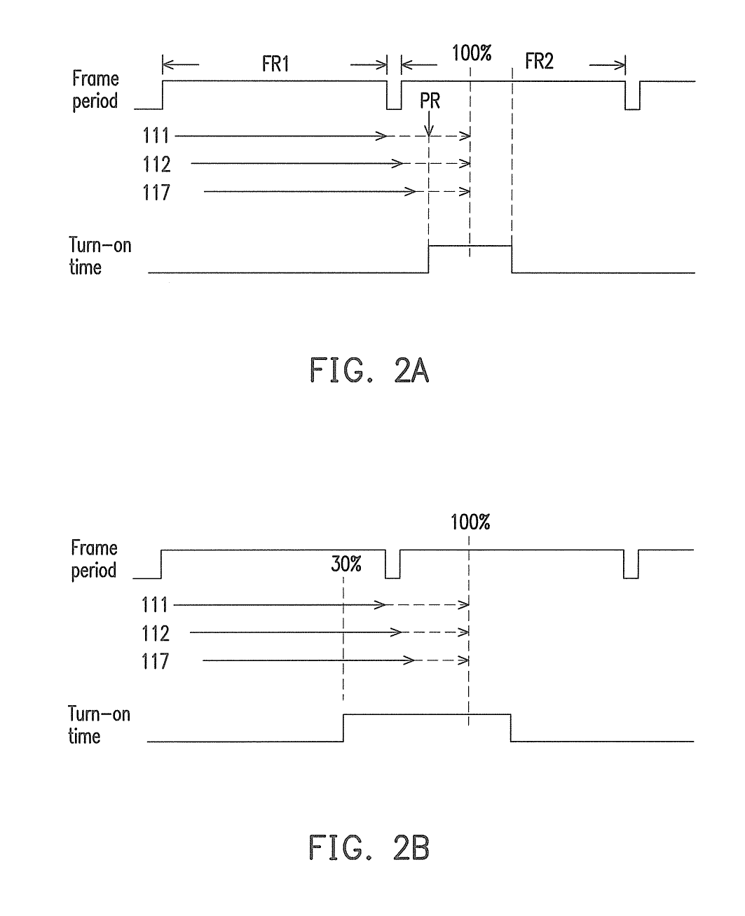

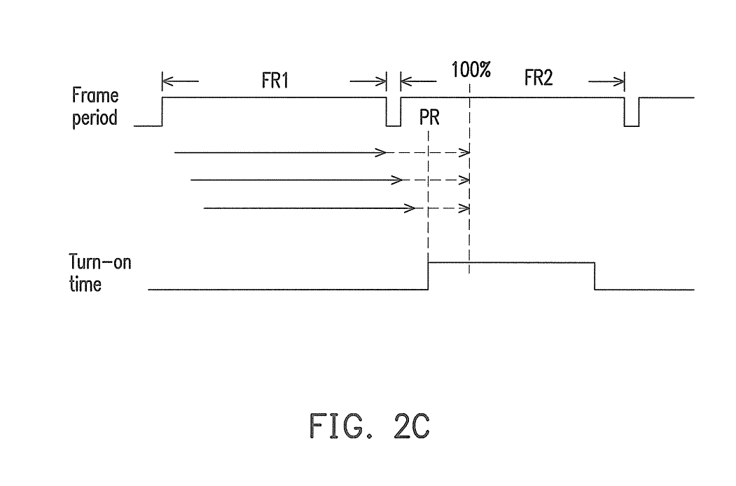

Referring to FIGS. 2A-2C, FIGS. 2A-2C are schematic diagrams respectively illustrating the backlight module 130 turned on at different time points according to an embodiment of the invention. Referring to FIG. 2A, the display regions 111-117 receive the over-driving voltages, and when the ratio between the number of the pixel units with the liquid crystals rotated to the steady state and the total number of the pixel units is greater than a predetermined ratio PR, the backlight module 130 is turned on. Moreover, the backlight module 130 is turned off at one-half of a frame period FR2. In the present embodiment, a time point of turning on the backlight module 130 can be adjusted to a time point after a frame period FR1 is ended. Namely, the turn-on time point of the backlight module 130 can be set between the end of the frame period FR1 and one-half of the frame period FR2.

Referring to FIG. 2B, the time point of turning on the backlight module 130 can be adjusted to a time point when the ratio between the number of the pixel units with the liquid crystals rotated to the steady state and the total number of the pixel units is greater than the predetermined ratio 30% (where the predetermined ratio PR of FIG. 2A is greater than 30%). Namely, by adjusting ahead the time point for turning on the backlight module 130, the turn-on time of the backlight module 130 is increased.

Finally, referring to FIG. 2C, a time point for turning off the backlight module 130 can be postponed. Namely, the turn-on time of the backlight module 130 can be started from the time point when the ratio between the number of the pixel units with the liquid crystals rotated to the steady state and the total number of the pixel units is greater than the predetermined ratio PR to a time point when the frame period FR2 is about to be ended.

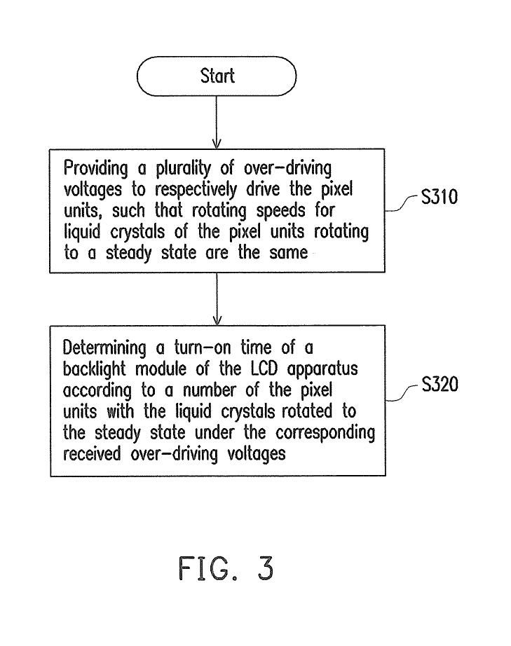

Referring to FIG. 3, FIG. 3 is a flowchart illustrating a driving method of a display apparatus according to an embodiment of the invention. The driving method of the display apparatus of the embodiment is adapted to a LCD apparatus having a plurality of pixel units arranged in an array, and the driving method can be described as follows. A plurality of over-driving voltages is provided to respectively drive the pixel units in different display regions, such that rotating speeds for liquid crystals of the pixel units rotating to a steady state are the same (S310). Moreover, a turn-on time of a backlight module of the LCD apparatus is determined according to a number of the pixel units with the liquid crystals rotated to the steady state under the corresponding received over-driving voltages (step S320).

Operation details of the driving method of the LCD apparatus of the present embodiment have been described in detail in the aforementioned embodiment with reference of the LCD apparatus, so that detailed descriptions thereof are not repeated.

In summary, in the invention, the LCD panel is divided into a plurality of the display regions according to a driving sequence of the pixel units, and different over-driving voltages are provided to different display regions, so that times for the pixel units in the LCD panel reaching the steady state are consistent. Moreover, by setting the turn-on time of the backlight module of the LCD apparatus according to a ratio of the number of the pixel units reaching the steady state, the motion blur phenomenon of the LCD apparatus can be effectively mitigated, and the display performance thereof is improved.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A liquid crystal display (LCD) apparatus, comprising:
a LCD panel, having a plurality of pixel units arranged in an array;
an over-driving voltage provider, coupled to the LCD panel, arranged for providing a plurality of over-driving voltages to respectively drive the pixel units, such that rotating speeds for liquid crystals of the pixel units rotating to a steady state are the same; and
a backlight module, arranged for determining a turn-on time according to a number of the pixel units with the liquid crystals rotated to the steady state under the corresponding received over-driving voltages.

2. The LCD apparatus as claimed in claim 1, wherein the LCD panel is divided into a plurality of display regions, the over-driving voltage provider comprises a plurality of over-driving look-up tables respectively corresponding to the display regions of the LCD panel, and each of the over-driving look-up tables provides one of the over-driving voltages to the corresponding display region according to image data.

3. The LCD apparatus as claimed in claim 1, wherein during the turn-on time, the liquid crystals of all of the pixel units are rotated to the steady state.

4. The LCD apparatus as claimed in claim 1, wherein when a ratio between the number of the pixel units with the liquid crystals rotated to the steady state and a total number of the pixel units is greater than a predetermined ratio, the backlight module is turned on correspondingly.

5. The LCD apparatus as claimed in claim 1, wherein the turn-on time is started when the predetermined ratio is equal to 30%.

6. The LCD apparatus as claimed in claim 1, wherein the turn-on time is set between an end of a first frame period and one-half of a second frame period, and the second frame period is connected behind the first frame period.

7. The LCD apparatus as claimed in claim 1, wherein the turn-on time is not greater than a frame period of the LCD apparatus.

8. The LCD apparatus as claimed in claim 1, wherein the over-driving voltage received by the pixel units driven earlier has a first voltage value, and the over-driving voltage received by the pixel units driven later has a second voltage value, and the first voltage value is smaller than the second voltage value.

9. A driving method of a liquid crystal display (LCD) apparatus, wherein the LCD apparatus has a plurality of pixel units arranged in an array, the driving method comprising:
providing a plurality of over-driving voltages to respectively drive the pixel units, such that rotating speeds for liquid crystals of the pixel units rotating to a steady state are the same; and
determining a turn-on time of a backlight module of the LCD apparatus according to a number of the pixel units with the liquid crystals rotated to the steady state under the corresponding received over-driving voltages.

10. The driving method of the LCD apparatus as claimed in claim 9, wherein the step of providing the over-driving voltages to respectively drive the pixel units, such that rotating speeds for liquid crystals of the pixel units rotating to the steady state are the same comprises:
providing a plurality of over-driving look-up tables respectively corresponding to the pixel units; and
providing one of the over-driving voltages to the corresponding display region by each of the over-driving look-up tables according to image data.

11. The driving method of the LCD apparatus as claimed in claim 9, wherein during the turn-on time, the liquid crystals of all of the pixel units are rotated to the steady state.

12. The driving method of the LCD apparatus as claimed in claim 9, wherein the step of determining the turn-on time of the backlight module of the LCD apparatus according to the number of the pixel units with the liquid crystals rotated to the steady state under the corresponding received over-driving voltages comprises:
turning on the backlight module when a ratio between the number of the pixel units with the liquid crystals rotated to the steady state and a total number of the pixel units is greater than a predetermined ratio.

13. The driving method of the LCD apparatus as claimed in claim 12, wherein the turn-on time is started when the predetermined ratio is equal to 30%.

14. The driving method of the LCD apparatus as claimed in claim 9, wherein the turn-on time is set between an end of a first frame period and one-half of a second frame period, and the second frame period is connected behind the first frame period.

15. The driving method of the LCD apparatus as claimed in claim 9, wherein the turn-on time is not greater than a frame period of the LCD apparatus.
